(19) United States
(12) Patent Application Publication
(10) Pub. No.: US 2013/0160736 A1
(43) Pub. Date: Jun. 27, 2013

(54) INTAKE AIR FLOW CONTROL VALVE

(71) Applicant: MAHLE FILTER SYSTEMS JAPAN CORPORATION, Tokyo (JP)

(72) Inventors: Junichi MATSUZAKI, Shiki-shi (JP); Takashi Kawano, Kawagoe-shi (JP)

(73) Assignee: MAHLE FILTER SYSTEMS JAPAN CORPORATION, Tokyo (JP)

(21) Appl. No.: 13/719,956

(22) Filed: Dec. 19, 2012

(30) Foreign Application Priority Data
Dec. 27, 2011 (JP) 2011-284594

(51) Int. Cl. F02D 9/10

(52) U.S. Cl. CPC F02D 9/1075
USPC 123/337

(57) ABSTRACT

An intake air flow control valve comprises a metal shaft having a noncircular cross sectional shape; and a valve element fixed to the metal shaft and arranged to close and open a cross section of the intake passage with rotation of the metal shaft. The valve element is an integral unit including a resin part of resin material and a metal part of metallic material. The resin part includes an intermediate portion formed with a shaft receiving groove in which the noncircular metal shaft is fit. The metal part extends along the shaft receiving groove, and includes a wide section to regulate fluid flow.

### BACKGROUND OF THE INVENTION

The present invention relates to improvement in a flow control valve such as an intake air flow control valve disposed in an intake air passage of an internal combustion engine as a swirl control valve or a tumble control valve.

A Japanese patent document JP 2003322024A discloses an intake air flow control valve to open and close a part of a flow passage cross section of an intake passage for each cylinder at a position upstream of an intake port of an internal combustion engine. To open and close the intake air control valves for a plurality of cylinders simultaneously, there is provided a long metallic shaft extending through a plurality of the intake passages, and a plurality of metallic oblong valve elements are fixedly mounted on the metallic shaft. The valve elements in the form of metallic plate are fastened to the metallic shaft in the state in which the metallic shaft is installed in an intake manifold, etc., by screw fastening operations in respective intake passages.

A Japanese patent document JP 2006070720A discloses an intake air flow control valve designed to avoid the above-mentioned screw fastening operations in a narrow space. Valve elements made of a synthetic resin are installed, respectively, in openings of intake passages of an intake manifold etc., and thereafter a metallic shaft having a rectangular cross section is inserted in an axial direction into holes of the valve elements. Thus, the resin valve elements are fixedly mounted on the metallic shaft with no need for screw fastening operation.

### SUMMARY OF THE INVENTION

The construction to fasten the metallic valve elements to the metallic shaft with screw fasteners as disclosed in the patent document JP 2003322024A requires screw fastening operation in a narrow space. Therefore, the workability is poor and the assembly process is time-consuming. Moreover, a screw fastener might be loosen and disengaged by vibrations, and sucked into the intake port of the engine.

In the construction proposed by the patent document JP 2006070720 A, the assembly process is made easier. However, the resin valve elements are unsatisfactory in the reliability of the mechanical strength as compared to the metallic valve elements. For example, an outer circumferential edge of the resin valve element might be broken or chipped by an undesired force. Moreover, the resin valve element might be unable to meet legal requirements in some countries.

Therefore, it is an object of the present invention to provide a flow control valve facilitating the assembly process and ensuring the reliability in the mechanical strength.

According to one aspect of the present invention, an intake air flow control valve comprises: a metal or metallic shaft having a rectangular or noncircular cross sectional shape; and a valve element fixed to the metal shaft and arranged to close and open at least a part of a cross section of the intake passage with rotation of the metal shaft. The valve element includes a resin part and a metal part. The resin part is a rod-shaped resin part made of a synthetic resin, the resin part extending in a longitudinal direction from a first end portion to a second end portion and including an intermediate portion extending between the first and second end portions, each of the first and second end portions being formed with a journal portion to be supported by a bearing portion, the intermediate portion being formed with a shaft receiving groove opening in one side and closing three sides of the metal shaft. The metal part is a metal blade in the form of a metal plate of a metallic material and fixed to the resin part, the metal blade extending in the longitudinal direction between the journal portions, and including a spread portion to close and open at least part of the cross section of the intake passage.

According to another aspect of the invention, a flow control apparatus comprising at least one flow control valve which comprises: a support member; a metal shaft which is rotatably supported by the support member, and which has a noncircular cross sectional shape; and a valve element fixedly mounted on the metal shaft to be rotated to regulate a fluid flow. The valve element includes a resin part and a metal or metallic part. The resin part is a part made of a synthetic resin, the resin part extending in a longitudinal direction from a first end portion to a second end portion and including an intermediate portion extending between the first and second end portions, each of the first and second end portions being formed with a journal portion supported by the support member, the intermediate portion being formed with a shaft receiving groove in which the metal shaft is fit. The metal part is a metal blade of a metallic material fixed with the rein part, the metal blade extending in the longitudinal direction between the journal portions of the resin part, and including a wide section to regulate the fluid flow.

### BRIEF DESCRIPTION OF THE DRAWINGS

FIG. 1 is a perspective view showing intake air flow control valves according to a first embodiment of the present invention employed as swirl control valves for an inline four (four-cylinder) engine.

FIG. 2 is a plan view showing a bearing frame with a bearing member for one of the flow control valves shown in FIG. 1.

FIG. 3 is a perspective view of the bearing frame without the bearing member.

FIG. 4 is a perspective view of the bearing member without the bearing frame.

FIG. 5 is a perspective view of a valve element according to the first embodiment.

FIG. 6 is a plan view of the valve element of FIG. 5.

FIG. 7 is a sectional view taken across a line A-A shown in FIG. 6.

FIG. 8 is a side view as viewed from a direction of an arrow B shown in FIG. 6.

FIG. 9 is a sectional view taken across a line C-C shown in FIG. 6.

FIG. 10 is a perspective view of a metal blade of the valve element of FIG. 5.

FIG. 11 is a perspective view of a valve element according to a second embodiment.

FIG. 12 is a sectional view taken across a line D-D shown in FIG. 11.

FIG. 13 is a side view as viewed from a direction of an arrow E in FIG. 11.

FIG. 14 is a perspective view of a rod-shaped resin part of the valve element of FIG. 11.

FIG. 15 is a plan view of the rod-shaped resin part of FIG. 14.

FIG. 16 is a plan view of a metal blade of the valve element of FIG. 11.

FIG. 17 is an exploded perspective view showing a valve element according to a third embodiment.

FIG. 18 is a perspective view showing the valve element of FIG. 17 in the assembled state.

FIG. 19 is a perspective view showing an inner structure of the valve element of FIG. 18 with broken lines.

### DETAILED DESCRIPTION OF THE INVENTION

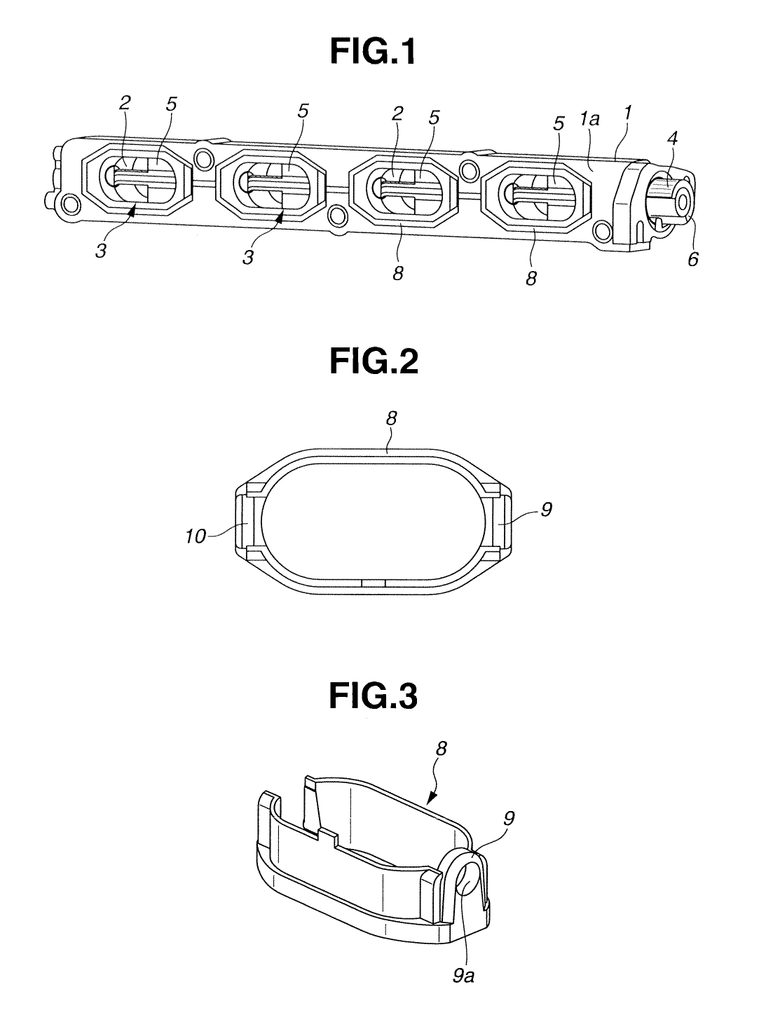

FIGS. 1˜11 are views for illustrating a first embodiment of the present invention. FIG. 1 shows the first embodiment in which the present invention is applied as swirl control valve of an internal combustion engine which, in this example, is an inline four engine.

A control valve housing 1 shown in FIG. 1 is a long member to be sandwiched between a side surface of a cylinder head (not shown) on an intake port's side and an intake manifold (not shown). Control valve housing 1 may be a casting of aluminum alloy or a molding of hard synthetic resin. Control valve housing 1 includes four openings 2 (intake passage portions) of an oval or oblong shape, corresponding to intake ports (not shown), respectively.

Intake air flow control valves 3 are disposed, respectively, in the openings 2 of control valve housing 1. In this example, the four intake air flow control valves 3 are swirl control valves. Each of the four swirl control valves 3 is a kind of butterfly valve and includes a valve element or disc element 5. The four valve elements 5 are fixedly mounted on a shaft 4 of a metallic material extending in a cylinder row direction of control valve housing 1. This metal shaft or metallic shaft 4 has a noncircular cross section such as a rectangular or square cross section, and includes an actuator connecting portion 6 formed in one end portion of metal shaft 4, and adapted to be connected with an actuator (not shown). Metal shaft 4 is arranged to be rotated by the actuator, and to open or close the four valve element 5 simultaneously.

A bearing frame 8 is fit in each of the openings 2 of control valve housing 1. Each bearing frame 8 has an annular oval or oblong shape conforming to the oval shape of the openings 2. Each bearing frame 8 is made of synthetic resin. Each bearing frame 8 includes first and second bearing portions 9 and 10 on left and right sides, to support the corresponding valve element 5 rotatably. The metal shaft 4 extends through the four valve elements 5 supported, respectively by the four bearing frames 8, sequentially so as to transfix the valve elements 5 like a skewer. Therefore, the assembly process includes a first operation of attaching the valve elements 5, respectively, to the bearing frames 8, a second operation of fitting the four bearing frames 8 each assembled with one valve element 5, in the four openings 2 of control valve housing 1, respectively, and a third operation of inserting the metal shaft 4 axially (in its axial direction). In this way, the valve elements 5 are fixedly mounted on the metal shaft 4 without the need of screw fastening operations.

Control valve housing 1 includes a first joint surface 1a for joining with the cylinder head on a first side shown in FIG. 1, and a second joint surface for joining with the intake manifold on a second side which is a back side as viewed in FIG. 1. In one example, the bearing frames 8 are attached to the openings 2 from the first side (1a) of control valve housing 1. However, it is possible to dispose the bearing frames 8 on the second side of control valve housing 1 opposite to the first side. At least one of bearing frames 8 can serve as a support member to support the valve stem or valve shaft (metal shaft 4), singly or in combination with valve housing 1.

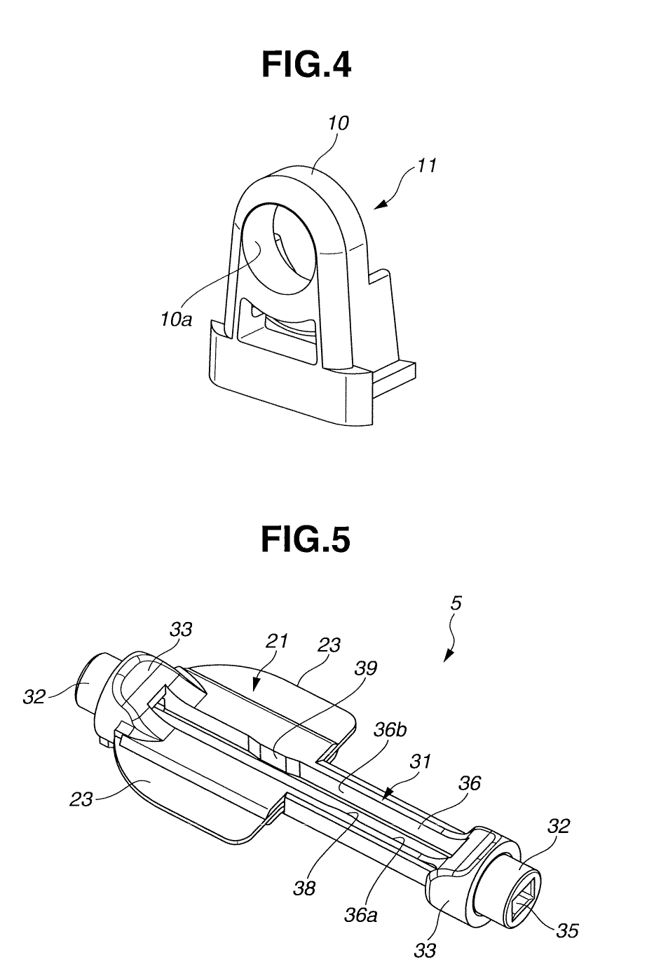

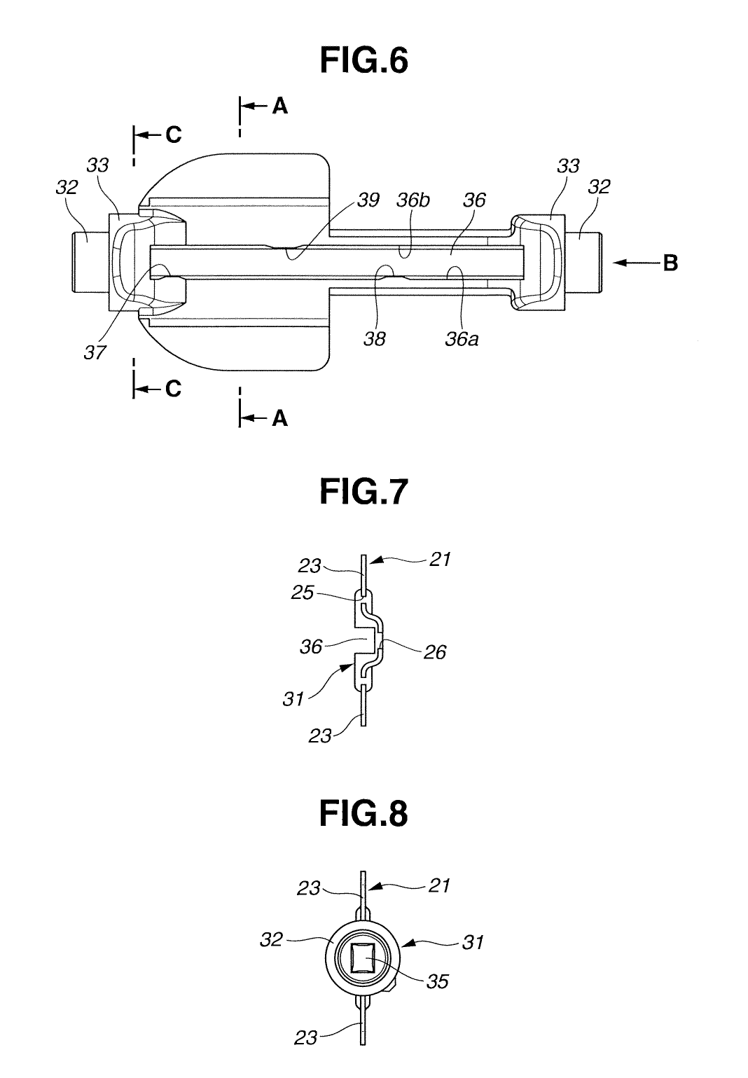

FIG. 2 is a plan view showing one of bearing frames 8 as viewed from the back side of FIG. 1. FIG. 3 is a perspective view of the bearing frame of FIG. 2 as viewed from the back side of FIG. 1. As shown in FIG. 2, the first and second bearing portions 9 and 10 are arranged substantially in a symmetric manner of bilateral symmetry on the left and right sides. However, the first bearing portion 9 is an integral part of the bearing frame 8 as shown in FIG. 3, whereas the second bearing portion 10 is a separate bearing member 11 separate from the bearing frame 8 as shown in FIG. 4. The bearing member 11 can be installed and removed in the bearing frame 8 by sliding the bearing member 11 in the axial direction. With this arrangement, the valve element 5 can be assembled into circular bearing holes 9a and 10a of first and second bearing portions 9 and 10 (11).

FIGS. 5˜10 show the construction of the valve elements 5 forming a characteristic feature of the present invention. The valve element or disc element 5 shown in FIG. 5 includes a metal part in the form of a metal blade or metallic plate 21 and a resin part 31 in the form of a rod-shaped part made of a resin which is a hard synthetic resin in this example. The resin part 31 is formed integrally with the metal part or metal blade 21. In this example, the rod-shaped resin part 31 is formed integrally with the metal blade 21 by an insert molding. The rod-shaped resin part 31 is formed by setting the metal blade 21 formed preliminarily in a predetermined form, in a molding die, and injecting or pouring a molten synthetic resin material into this molding die so that the resin part 31 covers or tightly enclose at least a part of the metal blade 21, and the metal blade 21 is buried in the resin part 31 at least partly.

The metal blade 21 is a metallic thin piece formed by press forming of metal plate or metal sheet. As shown in FIG. 10, the metal blade 21 includes a channel-shaped beam portion 22 extending axially, and a pair of spread portions 23 spreading to both sides in an imaginary common single plane, from the beam portion 22. The beam portion 22 has a shallow U-shaped cross sectional shape formed by bending. The beam portion 22 includes a first segment formed with the spread portions 23 and a second segment formed with a pair of side walls 24. The first segment extends in the axial direction from one end (a first end on the left side as viewed in FIG. 10)) of metal blade 21 to the second segment, and the second segment extends continuously from the first segment to the other end (a second end on the right side in FIG. 10) of metal blade 21. The (axial) length of the first segment of beam portion 22 is approximately equal to a half of the axial length of metal blade 21 so that the spread portions 23 are formed over an axial length approximately equal to a half of the axial length of metal blade 21. The length of the second segment is also approximately equal to a half of the axial length of metal blade 21. The side walls 24 projects from the first segment of beam portion 22 so that the side walls 24 stand upright from the imaginary common plane in which the spread portions 23 spread.

Each of the spread portions 23 includes an edge 23a curved in conformity with the shape of the intake passage (specifically, the shape of the inside circumferential surface of bearing frame 8). In this example, the edge 23a includes an end portion curved like a circular arc in conformity with the oblong shape of the intake passage. Moreover, each of the spread portions 23 includes a base portion which extends near the beam portion 22 along beam portion 22 and which is formed with a plurality of small holes 25 to connect layers of the synthetic resin formed on both sides of the spread portion 23. Moreover, the bottom of beam portion 22 is formed with an axially extending slit 26 to increase the joining strength with the part of the synthetic resin.

Each of the ends of metal blade 21 in the longitudinal direction is formed with a pair of retaining portions 27 for preventing falling. At each end, the retaining portions 27 projects from the side walls 24 of beam portion 22, and the retaining portions 27 are bent inwards toward each other so as to form a C-shaped cross section with the beam portion 22. In the example shown in FIG. 10, the forward ends of retaining portions 27 are slightly spaced from each other, and arranged to confront each other across a narrow space. However, it is optional to form the retaining portions 27 so that the forward ends are in contact with each other with no space therebetween.

The thus-formed metal blade 21 extends longitudinally in the axial direction from the first end formed with the retaining portions 27, to the second end formed with the retaining portions 27. The first segment of beam portion 22 extends longitudinally from the first end to an intermediate (or middle) point of metal blade 21 at which the first and second segments are connected end to end so. Except for the end portion formed with the retaining portions 27, the spread portions 23 expand from the second segment, like wings so as to form the form of a round fan. The second segment of beam portion 22 extends from the intermediate point to the second end of metal blade 21, as to form a continuous single rod, like a long and narrow rod having a small width equaling the width of the beam portion. Thus, the metal blade 21 includes a wide blade portion formed by the spread portion 23 and the first segment of beam portion 22, a narrow blade portion formed only by the second segment of beam portion 22, a first blade end portion formed by an end portion of the first segment of beam portion 22 and the retaining portions 27, and a second blade end portion formed by an end portion of the second segment of beam portion 22 and the retaining portions 27.

The rod-shaped resin part 31 is a molding of the hard or rigid synthetic resin produced by a die forming process, so as to wrap or envelope the metal blade 21 partly. In the narrow blade portion of metal blade 21 having no spread portions, a resin portion of the synthetic resin is formed inside the channel shaped second segment (between the side walls 24) of beam portion 22. In the wide blade portion of metal blade 21, the synthetic resin extends on both sides of each of spread portions 23, as shown in the sectional view of FIG. 7. The resin portions or layers on both sides of each spread portion 23 are connected together through the small holes 25 of metal blade 21, as shown in the sectional view of FIG. 7. The forward portions of spread portions 23 are left unburied so that the metallic surfaces are bared.

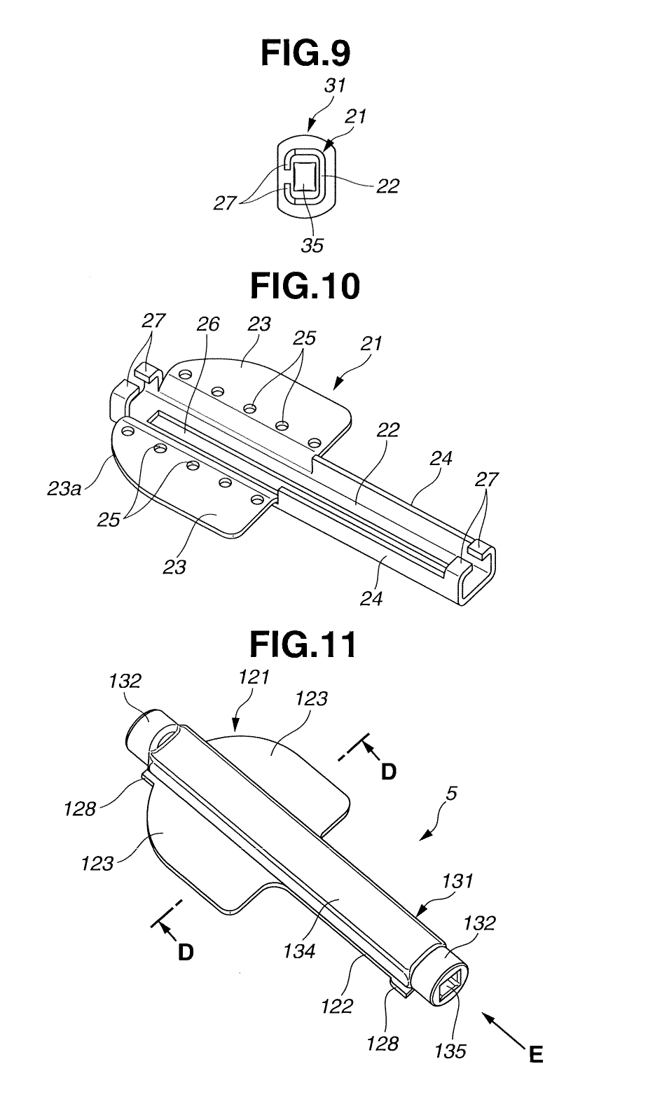

Thus, the external form of rod-shaped resin part 31 approximately conforms to the external form of metal blade 21. However, the rod-shaped resin part 31 includes cylindrical journal portions 32 formed, respectively, at both axial end portions of rod-shaped resin part 31 and arranged to be fit rotatably in bearing holes 9a and 10a of the bearing frame 8, respectively. Each of journal portions 32 is entirely made of the synthetic resin and the metal part 21 is not formed and extended in the journal portions 32. Furthermore, each of the axial end portions of rod-shaped resin parts 31 includes a flange 33 which is adjacent to the journal portion 32, which has a larger diameter than the outside diameter of journal portion 32 and which is arranged to limit axial movement of the valve element 5 (21, 31) in the bearing frame 8. In each of the axial end portions, the cylindrical journal portion 32 projects axially from the flange 33 to the forward end of journal portion 32, and the flange 33 includes an annular abutment surface surrounding the journal portion 32 and facing the forward end of journal portion 32. The cross sectional shape of the flange 33 is varied gradually from a circular shape to a rectangular shape, and the retaining portions 27 at the corresponding end of beam portion 22 are enveloped or buried in the flange 33 as shown in a sectional view of FIG. 9.

Two shaft receiving holes 35 and a shaft receiving groove 36 are formed in rod-shaped resin part 31. The shaft receiving groove 36 extends axially between the two shaft receiving holes 35 so as to form a continuous long hollow portion for receiving the metal shaft 4. The shaft receiving holes 35 are formed, respectively, in the end portions each including journal portion 32 and flange 33. In each end portion, the shaft receiving hole 35 extends through the journal portion 32 and flange 33 and has a rectangular cross sectional shape conforming to the cross sectional shape of metal shaft 4. The shaft receiving groove 36 is formed in the resin portion which is formed in the beam portion 22 between flange portions 33, and which extends axially on and along the inside surface of the beam portion 22, between flange portions 33. Each of the shaft receiving holes 35 encloses the four sides of metal shaft 4 whereas the shaft receiving groove 36 opens one side of metal shaft 4 and closes the other three sides, as best shown in FIG. 7.

First, second and third projections 37, 38 and 39 are formed in the shaft receiving groove 36 of rod-shaped resin part 31. First and second projections 37 and 38 are formed in a first side surface 36a defining the shaft receiving groove 36, and the third projection 39 is formed in a second side surface 36b confronting the first side surface 36a and defining the shaft receiving groove 36 between the first and second side surfaces 36a and 36b. The third projection 39 is located axially between the first and second projections 37 and 38. The groove dimension of shaft receiving groove 36 (or the width between the first and second side walls 36a and 36b of the shaft receiving groove 36) is determined basically in conformity with the cross sectional size of metal shaft 4. The first and second projections 37 and 38 project slightly from the first side surface 36a toward the second side surface 36b. The third projection 39 projects slightly from the second side surface 36b toward the first side surface 36a, at the axial position between the axial positions of first and second projections 37 and 38. Therefore, when the metal shaft 4 is inserted axially into valve element 5 in the assembly process, the projections 37 and 38 and the projection 39 are pressed on the opposite side surfaces of metal shaft 4 from both sides, so that metal shaft 4 is held or clamped between the projections 37 and 38 on one side and the projection 39 on the opposite side, at three points. This structure including the projections 37, 38 and 39 can fix the valve element 4 firmly and securely to metal shaft 4 regardless of dimensional errors and tolerance of some extent.

In this embodiment, the shaft receiving groove 36 is formed in the rod-shaped resin part 31. The metal shaft 4 and valve element 5 can be assembled together by a press fitting method by utilizing minute elastic deformation of the synthetic resin material more flexible than the metallic material. Therefore, this embodiment makes it possible to assemble the flow control valve such as the swirl control valve without the need for screw fastening operation.

In the state in which metal shaft 4 is fit in shaft receiving groove 36, the shaft receiving groove 36 receives reaction forces in expanding directions. However, the shaft receiving groove 36 is formed in the beam portion 22 of metal blade 21 and confined by the side walls 24 of beam portion 22 from both sides. Thus, the beam portion 22 of metal blade 21 reinforces the resin portion defining shaft receiving groove 36 and significantly reduces deformation over time as compared to a structure made only of the synthetic resin, so that valve element 5 can be held firmly and gripped for a long time.

The spread portions 23 for opening and closing the fluid passage are made from metal plate or metal sheet. Therefore, the valve element 5 is strong, reliable and free from undesired chipping and breakage. Furthermore, metal blade 21 extends almost over the full length of valve element 5 beyond the wide section including the spread portion 23. Therefore, the metal blade 21 improves the rigidity and strength of valve element 5 as a whole.

Moreover, metal blade 21 of this embodiment includes the retaining portions 27 which are shaped to form a closed or nearly-closed sectional shape surrounding the metal shaft 4. Therefore, the retaining portions 27 of metal blade 21 prevent the metal blade 21 from being disengaged from metal shaft 4 even if the rod-shaped resin part 31 is broken or lost partly or entirely, and retain the metal blade 21 in engagement with metal shaft 4 without the interposition of the resin material. Therefore, this retaining structure can prevent intrusion of the metal blade 21 into an internal combustion engine during operation of the engine, for example.

The retaining structure for preventing fall-off of blade 21 from metal shaft 4 is not limited to the illustrated structure in the form of local small pieces. For example, it is possible to employ the structure of the beam portion 22 formed entirely to have a cross sectional shape surrounding the four sides of metal shaft 4. In any case, the retaining structure is arranged to prevent the metal blade 21 from being extracted or disengaged laterally or radially from the metal shaft 4.

The valve element 5 of the first embodiment is formed by the insert molding so that metal blade 21 and rod-shaped resin part 31 are united as integral parts of a single unit. This production method comprises a forming process of forming the metal blade 21 and a molding process of forming the rod-shaped resin part 31 with the metal blade 21. This production method does not require further steps additionally and makes it possible to form the valve element 5 including the metal part and the resin part with a minimum number of steps.

FIGS. 11˜16 are views for illustrating a valve element 5 according to a second embodiment of the present invention. In the second embodiment, a metal part or metal blade 121 and a rod-shaped resin part 131 are produced individually, and then both parts n are jointed together.

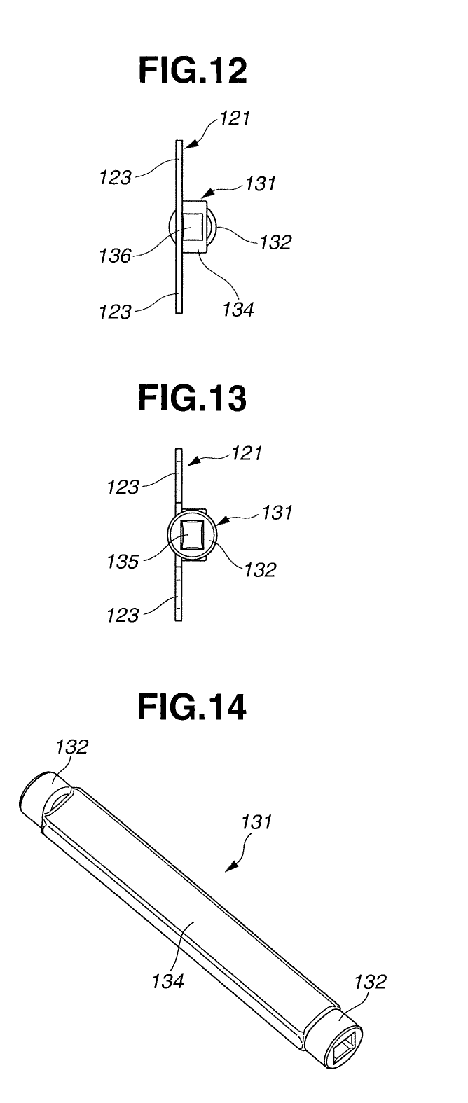

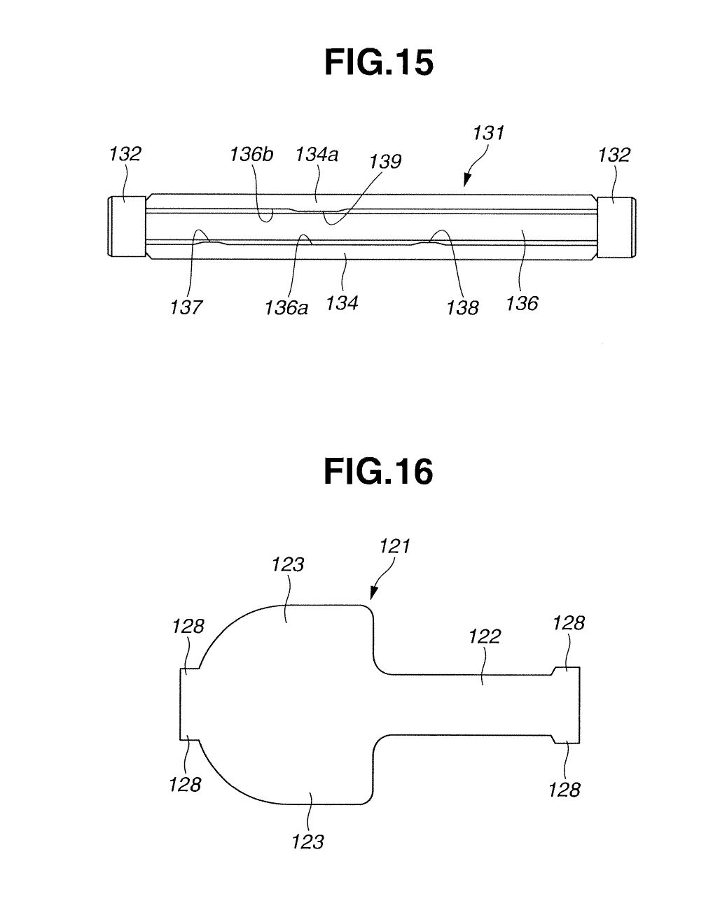

As shown in FIGS. 14 and 15, the rod-shaped resin part 131 of the synthetic resin includes journal portions 132 of a cylindrical shape at both ends, and a shaft portion or shank 134 extending between the journal portions 132. The shaft portion 134 is in the form of a rectangular column having a rectangular cross sectional shape whose width is approximately equal to the diameter of journal portions 132. Each of journal portions 132 is formed with a shaft receiving hole 135 which has a rectangular cross sectional shape conforming to the cross sectional shape of metal shaft 4, as shown in a sectional view of FIG. 13, and which extends through the journal portion 132. As shown in FIGS. 12 and 15, the shaft portion 134 is formed with a shaft receiving groove 136 connected continuously with the shaft receiving holes 135 of journal portions 132 on both sides to form a continuous shaft receiving hollow portion for receiving the metal shaft 4. Shaft receiving groove 136 has a rectangular cross section open in one side and closed in the other three sides to close three sides of metal shaft 4, like the shaft receiving groove 36. Like shaft receiving groove 36, first and second projections 137 and 138 are formed in one side surface 136a, and a third projection 139 is formed in the other side surface 136b confronting the side surface 136a.

Metal blade 121 is in the form of a flat metal plate. Metal blade 121 includes a wide section having spread portions 123 spreading on both sides; a narrow section or band portion 122; and first and second end portions each formed with stopper portions 128 projecting slightly outwards. The axial length of the wide section is approximately equal to a half of the axial length of metal blade 121. The wide section extends axially from the first end portion (on the left side as viewed in FIG. 16) to a middle of metal blade 121 located approximately at a middle of the axial length of metal blade 121. The narrow section 122 extends from the middle to the second end portion. The width of narrow section 122 is substantially equal to the width of shaft portion 134 of rod-shaped resin part 131. The total length of metal blade 121 corresponds to the length of shaft portion 134 of rod-shaped resin part 131

The thus-formed metal blade 121 is joined to an outer side surface 134a (joint surface) of shaft portion 134 of rod-shaped resin part 131 formed separately. The side surface 134a is a side surface of shaft portion 134 of rod-shaped resin part 131 in which the shaft receiving groove 136 is open. As the joining method, it is possible to employ a known method of coating predetermined primer on the side surface 134a of the resin side, and pressing the metal blade 121 heated to a high temperature. However, the joining method is not limited to this, and it is possible to employ various joining methods such as adhesion using an appropriate adhesive.

In the second embodiment, too, it is possible to insert the metal shaft 4 axially in a manner of press fit after the valve elements 5 are assembled in the bearing frames 8, respectively and the thus-formed subassemblies are installed in the control valve housing 1. Therefore, the second embodiment can improve the workability in the assembly process and the reliability in the mechanical strength.

The second embodiment can reduce the sizes of parts as compared to the first embodiment, and reduce the weight of the flow control valve.

In the second embodiment, no metal parts are provided on both sides of shaft receiving groove 136. However, metal blade 121 is joined to the open side of shaft receiving groove 136 (that is, the side surface 134a of rod-shaped resin part 131). Therefore, the shaft receiving groove 136 is constructed to have a closed sectional structure to restrain expanding deformation. Therefore, this structure can hold the valve element 5 firmly to metal shaft 4 for a long time.

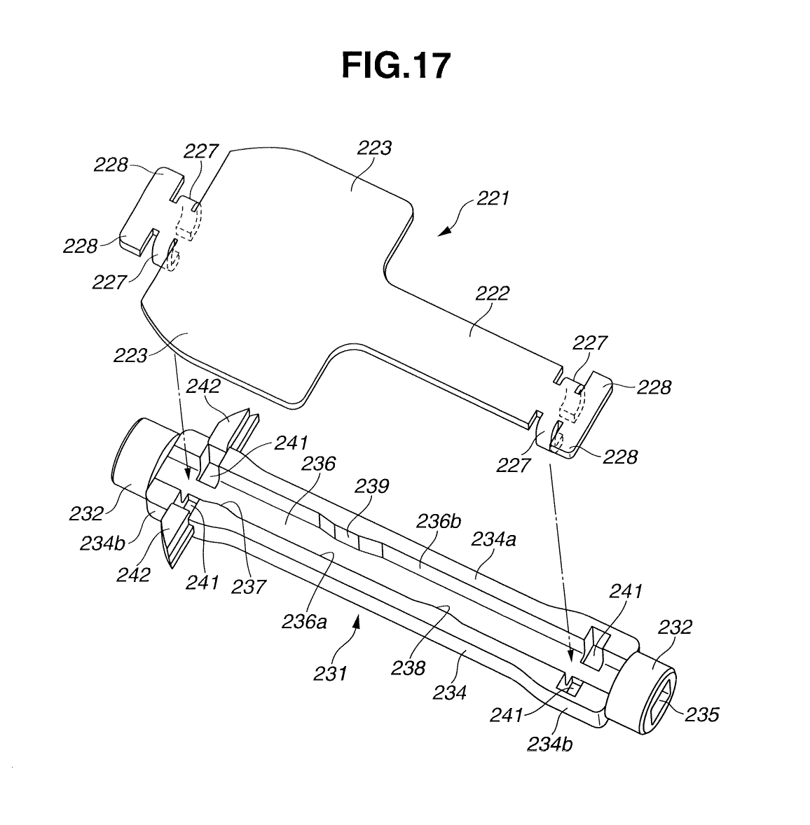

FIGS. 17˜19 are views for illustrating a valve element 5 according to a third embodiment of the present invention. In the third embodiment, a metal part or metal blade 221 and a rod-shaped resin part 231 are produced individually, and then both parts are jointed together, like the second embodiment.

As shown in FIG. 17, the rod-shaped resin part 231 of the synthetic resin includes journal portions 232 of a cylindrical shape at both ends, and a shaft portion or shank 234 extending between the journal portions 232. The shaft portion 234 is in the form of a rectangular column having a flat rectangular cross sectional shape whose width is slightly greater than the diameter of journal portions 132. Each of journal portions 232 is formed with a shaft receiving hole 235 which has a rectangular cross sectional shape conforming to the cross sectional shape of metal shaft 4, like the second embodiment, and which extends through the journal portion 232. The shaft portion 234 is formed with a shaft receiving groove 236 connected continuously with the shaft receiving holes 235 of journal portions 232 on both sides to form a continuous shaft receiving hollow portion for receiving the metal shaft 4. Shaft receiving groove 236 has a rectangular cross section open in one side and closed in the other three sides to close three sides of metal shaft 4, like the shaft receiving grooves 36 and 136. Like shaft receiving grooves 36 and 136, first and second projections 237 and 238 are formed in one side surface 236a, and a third projection 239 is formed in the other side surface 236b confronting the side surface 236a.

In the third embodiment, wider portions 234b are formed at both ends of shaft portion 234, between journal portions 232. Each of wider portions 234b is made slightly wider and formed with a pair of small rectangular holes 241 so as to overlap the shaft receiving groove 236 partly.

Metal blade 221 is basically in the form of a flat metal plate like the metal blade 121 of the second embodiment. Metal blade 221 includes a wide section having spread portions 223 spreading on both sides; a narrow section or band portion 222; and first and second end portions each formed with stopper portions 228 projecting outwards. The axial length of the wide section is approximately equal to a half of the axial length of metal blade 221. The wide section extends axially from the first end portion (on the left side as viewed in FIG. 17) to a middle of metal blade 221 located approximately at a middle of the axial length of metal blade 221. The narrow section 222 extends from the middle to the second end portion. The width of narrow section 222 is substantially equal to the width of shaft portion 234 of rod-shaped resin part 231. The total length of metal blade 221 corresponds to the length of shaft portion 234 of rod-shaped resin part 231. The stopper portions 228 correspond to the width of wider portions 234b of shaft portion 234.

In the third embodiment, metal blade 221 includes retaining portions 227 for preventing fall-off of the valve element from metal shaft 4, like the first embodiment. Each of the end portions of metal blade 221 includes a pair of the retaining portions 227 formed at a position adjacent to the stopper portion 228. Each of retaining portions 227 is formed by forming parallel cuts in the metal plate or sheet of metal blade 221, and bending a portion defined by the parallel cuts, toward the rod-shaped resin part 231. The pair of retaining portions 227 are bent inward so as to form a C-shaped cross section.

The thus-formed metal blade 221 is joined to an outer side surface 234a of shaft portion 234 of rod-shaped resin part 231 formed separately. The side surface 234a is a side surface of shaft portion 234 of rod-shaped resin part 231 in which the shaft receiving groove 236 is open. As the joining method, it is possible to employ the known method of coating predetermined primer on the side surface 234a of the resin side, and pressing the metal blade 221 heated to a high temperature, on to the primer coated surface. However, the joining method is not limited to this, and it is possible to employ various joining methods such as adhesion using an appropriate adhesive.

In this case, the four retaining portions 227 are fit, respectively in the rectangular small holes 241 of rod-shaped resin part 231. To absorb error or tolerance, there are provided slight allowance therebetween.

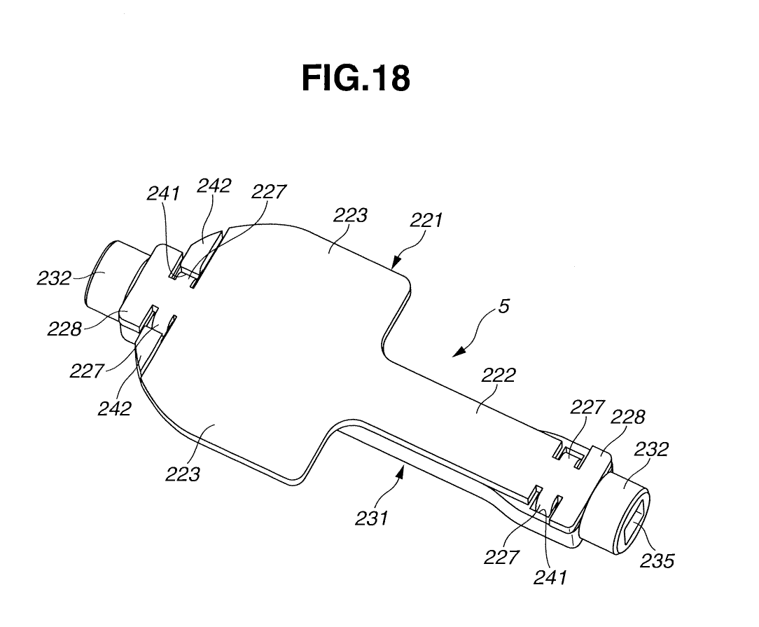

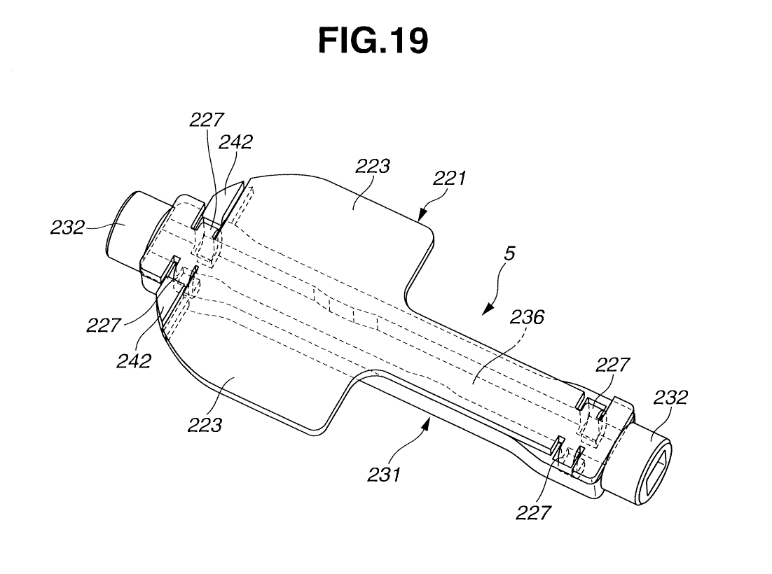

In the third embodiment, the wide section including spread portions 223 is in the form partly cut by the formation of the adjacent retaining portions 227 near the axial end of metal blade 221. Therefore, the rod-shaped resin part 231 is formed with a pair of small resin spread portions 242 projecting outward from a pair of small holes 241 near the first end (the left end in FIG. 17). In the assembled state, as shown in FIGS. 18 and 19, the resin spread portions 242 and the metal spread portions 223 of metal blade 221 are fit together continuously so as to form a continuous arched shape conforming to the shape of the oblong intake passage (the shape of the inside circumferential surface of bearing frame 8).

In the third embodiment, too, it is possible to insert the metal shaft 4 axially in a manner of press fit after the valve elements 5 are assembled in the bearing frames 8, respectively and the thus-formed subassemblies are installed in the control valve housing 1. Therefore, the third embodiment can improve the workability in the assembly process and the reliability in the mechanical strength as in the preceding embodiments.

In the assembled state, the retaining portions 227 of metal blade 221 surrounds the metal shaft 4 in the C-shaped form, as in the first embodiment. Therefore, the retaining portions 227 of metal blade 221 prevent the metal blade 221 from being disengaged from metal shaft 4 even if the rod-shaped resin part 231 is broken or lost partly or entirely, and retain the metal blade 221 in engagement with metal shaft 4 without the interposition of the resin material. Therefore, for example, this retaining structure can prevent intrusion of the metal blade 221 into an internal combustion engine during operation of the engine.

The retaining portions 27 or 227 are optional and not essential in the present invention. The retaining portions 27 or 227 are provided according to the need in dependence on legal requirement or the position of the flow control valve or other factors.

This application is based on a prior Japanese Patent Application No. 2011-284594 filed on Dec. 27, 2011. The entire contents of this Japanese Patent Application are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. An intake air flow control valve comprising:
a metal shaft which is arranged to traverse an intake passage of an internal combustion engine and to rotate, and which has a rectangular cross sectional shape; and
a valve element fixed to the metal shaft and arranged to close and open a part of a cross section of the intake passage with rotation of the metal shaft, the valve element including,
a rod-shaped resin part made of a synthetic resin, the resin part extending in a longitudinal direction from a first end portion to a second end portion and including an intermediate portion extending between the first and second end portions, each of the first and second end portions being formed with a journal portion to be supported by a bearing portion, the intermediate portion being formed with a shaft receiving groove opening in one side and closing three sides of the metal shaft, and
a metal blade in a form of a metal plate of a metallic material and fixed to the resin part, the metal blade extending in the longitudinal direction between the journal portions, and including a spread portion to close and open the cross section of the intake passage.

2. The intake air flow control valve as claimed in claim 1, wherein the metal blade includes a wide section including the spread portion and having a greater width and a narrow section extending along the rod-shaped resin part and having a smaller width smaller than the greater width, and the intake air flow control valve is a swirl control valve.

3. The intake air flow control valve as claimed in claim 1, wherein the shaft receiving groove of the resin part is defined between first and second side walls confronting each other, the fist side wall being formed with first and second projections to abut on a side surface of the metal shaft, and the second side wall being formed with a third projection to abut on a side surface of the metal shaft at a position between the first and second projections.

4. The intake air flow control valve as claimed in claim 1, wherein the metal blade includes a retaining portion extending around the metal shaft to prevent the metal blade from being disengaged laterally from the metal shaft.

5. The intake air flow control valve as claimed in claim 1, wherein the resin part is formed integrally with the metallic blade by insert molding.

6. A flow control apparatus comprising a flow control valve which comprises:
a support member;
a metal shaft which is rotatably supported by the support member, and which has a noncircular cross sectional shape; and
a valve element fixedly mounted on the metal shaft to be rotated to regulate a fluid flow, the valve element including,
a resin part made of a synthetic resin, the resin part extending in a longitudinal direction from a first end portion to a second end portion and including an intermediate portion extending between the first and second end portions, each of the first and second end portions being formed with a journal portion supported by the support member, the intermediate portion being formed with a shaft receiving groove in which the metal shaft is fit, and
a metal blade of a metallic material fixed with the rein part, the metal blade extending in the longitudinal direction between the journal portions of the resin part, and including a wide section to regulate the fluid flow.

7. The flow control apparatus as claimed in claim 6, wherein each of the journal portions of the resin part is formed with a shaft receiving hole having a noncircular cross section; and the shaft receiving holes of the first and second end portions of the resin part are connected continuously with the shaft receiving groove of the intermediate portion of the resin part so that the shaft receiving holes and the shaft receiving groove form a continuous hollow portion having a noncircular cross section and extending through the valve element.

8. The flow control apparatus as claimed in claim 7, wherein the metal blade is fixed with the intermediate portion of the rein part along the shaft receiving groove to reinforce the shaft receiving portion.

9. The flow control apparatus as claimed in claim 6, wherein the resin part includes a projection projecting in the shaft receiving groove and abutting against the metal shaft in the shaft receiving groove.

10. The flow control apparatus as claimed in claim 6, wherein the support member comprises a bearing frame including a first bearing portion supporting the journal portion of the first end portion of the resin part rotatably, and a second bearing portion supporting the journal portion of the second end portion of the resin part rotatably.

11. The flow control apparatus as claimed in claim 10, wherein the flow control apparatus comprises,
a plurality of subassemblies each including the valve element and the bearing frame,
a valve housing including a plurality of openings arranged in a line to receive the subassemblies, respectively, and
the metal shaft extending through the valve elements of the subassemblies in the valve housing.

12. The intake air flow control valve as claimed in claim 6, wherein the metal blade includes the wide section extending from a first end near the journal portion of the first end portion of the resin part to a second end toward the journal portion of the second end portion of the resin part, and a narrow section projecting in the longitudinal direction from the wide section to the flange portion of the second end portion of the resin part, along the shaft receiving groove.

13. The flow control apparatus as claimed in claim 6, wherein the metal blade includes a retaining portion extending circumferentially around the metal shaft to prevent the metal blade from being disengaged from the metal shaft.

14. The flow control apparatus as claimed in claim 6, wherein the metal blade includes side walls extending along the shaft receiving groove on both sides of the shaft receiving groove and bounding an inner resin portion of the resin part so that the shaft receiving groove is formed in the inner resin portion formed between the side walls of the metal blade.

15. The flow control apparatus as claimed in claim 6, wherein the resin part includes a joint surface in which the shaft receiving groove is open, and the metal blade is fixed to the joint surface of the resin part.
